(19) United States
(12) Patent Application Publication
(10) Pub. No.: US 2022/0343022 A1
(43) Pub. Date: Oct. 27, 2022

(54) METHOD FOR GENERATING AN ENCODED IMAGE, COMPUTER PROGRAM, STORAGE MEDIUM, AND ELECTRONIC IMAGE ANALYSIS DEVICE

(71) Applicant: Robert Bosch GmbH, Stuttgart (DE)

(72) Inventors: Jan Rexilius, Hannover (DE); Paul Robert Herzog, Hildesheim (DE)

(21) Appl. No.: 17/726,691

(22) Filed: Apr. 22, 2022

(30) Foreign Application Priority Data
Apr. 23, 2021 (DE) 10 2021 204 064.0

(51) Int. Cl. G06F 21/62; G06V 20/52; G06T 9/00; G06F 21/60

(52) U.S. Cl. CPC G06F 21/6254; G06V 20/52; G06T 9/00; G06F 21/602

(57) ABSTRACT

Method for generating an encoded image 1, wherein a camera system provides a camera image 2, wherein the camera image 2 comprises anonymous image sections 3 without personal data and sensitive image sections 4 containing personal data, wherein the camera image 2 is analyzed based on an image recognition algorithm to detect the sensitive image sections 4, wherein an encoded image 1 is generated, wherein in order to generate the encoded image 1 the sensitive image sections 4 of the camera image 2 are anonymized and image contents of the sensitive image sections 4 of the camera image are stored in the encoded image 1 in cryptographically encoded form.

### BACKGROUND OF THE INVENTION

The invention relates to a method for generating an encoded image, wherein a provided camera image comprises anonymous image sections without personal data, and sensitive image sections containing personal data.

Image-based surveillance is used in a wide range of everyday applications. For example, public buildings are monitored by security cameras for security purposes, wherein individuals can be recognized and/or tracked based on the surveillance images. In addition, image-based monitoring is carried out as part of an access authorization system, or for fire and/or smoke detection, for example. In some cases, evaluations based on neural networks and/or other machine learning methods are used. For the training of such networks, for example, to detect persons, large amounts of image data are required, the quality of which has a significant influence on the resulting trained neural networks. For example, images for training such neural networks should be as free as possible from artifacts, such as those resulting from masking.

The publication DE 101 58 990 C1 describes a video surveillance system having at least one camera for monitoring a scene, and a processor that is designed to identify at least one object in the scene. The video surveillance system has means for masking the at least one object in the scene. De-masking is performed depending on a predefined event.

### SUMMARY OF THE INVENTION

The invention relates to a method for generating an encoded image. The invention also relates to a computer program, a machine-readable storage medium, and an electronic image analysis device. Further advantages, effects and embodiments are obtained from the subclaims, the description and the attached figures.

A method for generating an encoded image is proposed. The method is intended in particular to be implemented on a computer. For example, the method is designed for execution on a computer, an electronic image analysis device, and in particular for execution on a surveillance camera. The method is used in particular to provide encoded images based on a camera image. In particular, the method is used to generate data protection-compliant images based on surveillance by means of a camera device. In particular, the method relates to the storage and protected encoding of sensitive personal data of a camera image in the form of the encoded image.

At least one camera image or video is and/or will be provided by a camera system, such as a surveillance camera. The camera image can be provided as part of the method or upstream of the method. In particular, a neural network or a machine learning algorithm will be trained based on the camera image, in particular since the camera image is designed to be domain-specific. The camera image preferably comprises anonymous image sections and sensitive image sections. Anonymous image sections are, for example, sections of the camera image that do not contain any personal data, data that is sensitive in terms of data protection law, or private data. Anonymous image sections show, for example, a background, and in particular are free of faces, number plates, or private data. Sensitive image sections relate, for example, to the faces of people, names, dates of birth, related persons, or number plates. For example, the camera image may show a car with a number plate on an empty road and a face of the driver, wherein the face of the driver and the number plate form sensitive image sections. In particular, camera images may be free of personal data, for example, if none of the same objects are captured by the camera system.

The camera image, the camera images and/or videos provided are analyzed. The analysis is preferably carried out using an image recognition algorithm, preferably based on a neural network. The camera image is analyzed in order to detect the sensitive image sections in the camera image, the camera images or videos. For example, the camera image is analyzed for the presence of image sections containing the personal data, for example, for the presence of faces, number plates, or other personal data. In particular, the analysis is used for clustering and/or to divide the camera image into the anonymous image sections and the sensitive image sections.

An encoded image is created, specified, stored, and/or generated. The encoded image is generated in particular based on the camera image. The encoded image, for example, should be understood as an anonymized camera image. To generate the encoded image, the sensitive image sections of the camera image, in particular those that have been analyzed and/or detected using the image recognition algorithm, are anonymized. In particular, anonymized is understood to mean the personal data in the camera image is represented in unrecognizable, illegible, or modified form.

The sensitive image sections comprise and/or display image contents. For example, the image content is a face of a person shown or a legible number plate of a private car. To generate the encoded image, the image contents of one or more sensitive image sections are encoded, in particular cryptographically encoded. The image contents, in particular cryptographically encoded, are stored and/or deposited in and/or together with the encoded image. For example, the encoded image is to be understood as an image based on the camera image in which the sensitive image sections are represented in anonymized form, and the image content of the sensitive image section is stored on and/or with the latter in encoded, in particular cryptographically encoded, form. The encoded image thus contains the anonymous image sections, the sensitive image sections in anonymized form, and cryptographically encoded image contents. The sensitive image sections stored and/or deposited in cryptographic form are not visible to, readable or identifiable by an unauthorized user or the general public.

The invention allows the plurality of the required images from a camera device to be provided for training neuronal networks and/or machine learning algorithms while complying with data protection. In order also to enable training in the field of person recognition or similar, by using the encoded image the method allows the neural network to be provided with the original data or original contents of the anonymized sensitive image sections in the form of the cryptographically encoded contents, in addition to the anonymized images. In particular, it is thus not necessary to store camera images twice, for example as an anonymized image for a larger user group and as an original image for a restricted user group. By storing the personal data in the encoded image itself, this information is invisible to the unauthorized user and can be decoded by the authorized user.

One embodiment of the invention provides that in order to generate the encoded image, an intermediate image based on the camera image is generated, stored and/or, in particular, stored, created or generated locally. In particular, the intermediate image forms the camera image in which the sensitive image sections are anonymized, for example, masked or rendered unrecognizable. The K cryptographically encoded sensitive image sections are stored in, deposited in, and/or attached to this intermediate image. The encoded image thus forms, in particular, the intermediate image in which the sensitive image sections are deposited and/or stored in encoded form. In particular, the cryptographically encoded sensitive image sections can be decoded, in particular by the authorized user and/or a restricted user group.

Preferably, the encoding, in particular cryptographic encoding, of the image contents of the sensitive image sections is carried out based on and/or by means of steganography. In particular, algorithms and/or methods of computer-assisted steganography are used. Steganography here is understood to mean not only the steganography of encoding information, but additionally includes the undetectable insertion and/or transmission of the cryptographically encoded content. This embodiment is based on the idea of depositing and/or storing the encoded image contents in the encoded image in an unrecognizable, inconspicuous, and/or concealed form.

In particular, it is provided that the storage and/or depositing of the encoded sensitive image sections is invisible, unrecognizable, and/or concealed. In particular, the term invisible, concealed and/or inconspicuous is to be understood to mean that it is not obvious to a viewer of the encoded image by sight, or with the naked eye, that additional data is present, deposited and/or stored along with the anonymous image sections and the anonymized sensitive image sections. For example, the invisible storage takes the form of an invisible watermark in the intermediate image. The cryptographic encoding is advantageous, as it generates a noise pattern from the sensitive image data, which, when inserted in the image as a watermark, produces only minor or no conspicuous visible image artifacts.

In particular, it is provided that the encoded sensitive image contents are deposited and/or stored in the intermediate image and/or in the encoded image by means of a least-significant-bit algorithm. Alternatively and/or in addition, the cryptographically encoded sensitive image contents can be saved in a JPEG image, in particular the encoded image and/or intermediate image, in the previously quantized DCT coefficients (discrete cosine transform coefficients). Alternatively and/or in addition, methods and/or algorithms for depositing data are used, in particular those designed for depositing and/or storing data invisibly and/or in concealed form. It is important that the cryptographically encoded information is inserted into the final (possibly previously compressed) image, because a lossy compression can destroy the encoded information and a lossless compression does not yield any benefit for cryptographically encoded information.

One embodiment of the method provides that the image contents of the sensitive image sections, which are in particular cryptographically encoded, are stored and/or deposited as metadata of the encoded image and/or intermediate image. For example, the metadata is stored in a header of the image. Alternatively and/or in addition, the metadata is stored as an attachment to the encoded image, in particular an encoded image attachment.

A further embodiment encodes the sensitive image contents preferably in the previously masked image sections, as these have been made unrecognizable anyway and thus do not contain any relevant information. For example, the encrypted sensitive image contents, which after encryption are only present as a visual noise pattern, can overwrite the corresponding regions in the masked image. The advantage of this is that no invisible watermark needs to be encoded in these regions, but all information can be overwritten instead.

The sensitive image sections describe, comprise, and/or show, in particular, faces, facial features, vehicle number plates, dates of birth, passport information, and/or private information in textual form. For example, the image recognition algorithm is designed to detect faces, number plates, dates of birth, passport data, and/or private information in textual form, for example based on a neural network or other machine learning methods.

In particular, it is provided that for the anonymization, the sensitive image section and/or the image content of the sensitive image section are replaced by an average image content, in particular the associated average image content. For example, if the sensitive image section and/or image content of the sensitive image section is a person's face, then for the anonymization an average face will replace the face actually shown. For example, the average image content can be understood as dummy image content. In particular, the average image content describes a corresponding content of the sensitive image section in a realistic manner. For example, number plates are replaced by a sample number plate, wherein textual private information is replaced by filler text, for example. In particular, the anonymization and/or replacement by the average image content is carried out based on and/or by means of a generative auxiliary network (GAN). For example, the camera images are processed using the GAN to form the intermediate image, wherein in the intermediate image the sensitive image section is replaced by an average image content.

Preferably, the cryptographic encoding of the image content of the sensitive image section is based on and/or carried out by means of asymmetric encryption, preferably by means of a binary encoding and/or a public and private key.

The storage of the encoded image information is preferably robust against image manipulations, in particular against image scaling, rotation, and/or noise.

A further aspect of the invention is formed by a computer program for execution on a computer, the surveillance camera, or an image analysis device. In particular, the computer program comprises program code. The computer program is designed and/or configured to support, execute, control, and/or apply the method during its execution.

A further aspect of the invention is formed by a storage medium, in particular a machine-readable storage medium and/or non-volatile storage medium. The computer program and/or the program code of the computer program is stored on the storage medium.

Another aspect of the invention is formed by an image analysis device. Specifically, the image analysis device comprises and/or forms a surveillance camera and/or part of the surveillance camera. The electronic image analysis device is designed and/or configured to execute the method for generating the encoded image, in particular the method steps. The electronic image analysis device comprises, for example, an image recognition module, the image recognition module being designed and/or configured to analyze the camera image using an image recognition algorithm, wherein sensitive image sections are encoded. In addition, the electronic image analysis device preferably comprises an encoding module, the encoding module being designed to encode the image contents of the sensitive image section(s) and to store them in an intermediate image based on the camera image. The intermediate image is formed, for example, by the camera image in which image contents of the sensitive image sections and/or sensitive image sections are anonymized.

### BRIEF DESCRIPTION OF THE DRAWINGS

Further advantages, embodiments and effects are obtained from the attached FIGURE and its description. In the drawing

FIG. 1 shows an exemplary embodiment of a method for generating an encoded image.

### DETAILED DESCRIPTION

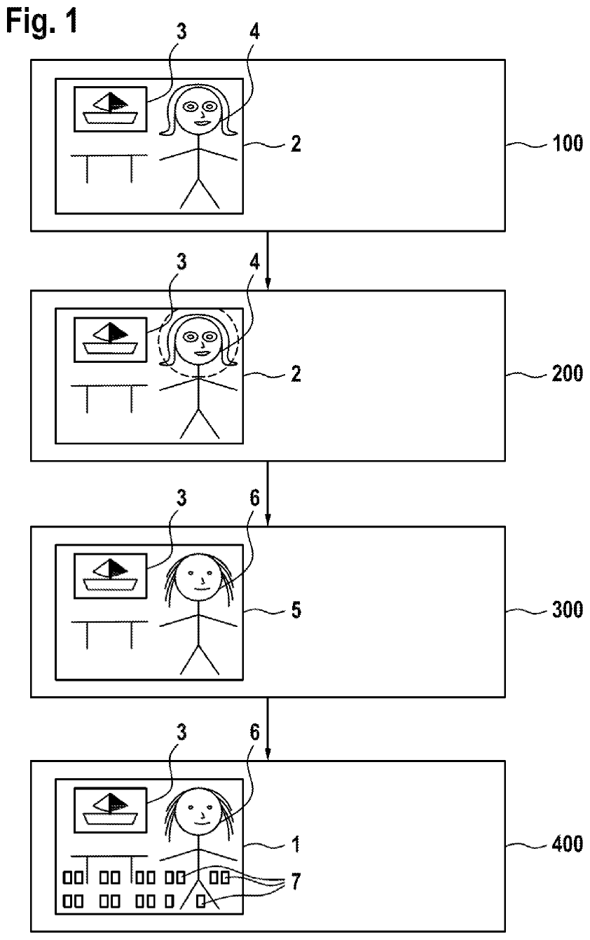

FIG. 1 is an exemplary embodiment of a method for generating an encoded image 1 based on a camera image 2. In a method step 100, the camera image 2 is acquired or provided. The camera image 2 is, for example, the camera image of a surveillance camera, and in particular a color image. The camera image preferably comprises anonymous sections 3 and sensitive image sections 4. The anonymous image sections 3 are parts of the camera image 2 without data and/or information that is personal and/or covered by data protection law. For example, trees, pieces of furniture and/or background objects in the camera image 2 are counted as anonymous image sections 3. Sensitive image sections 4 are those sections of the camera image 2 that show personal data and/or information covered by data protection law. For example, faces, dates of birth, textual information and/or number plates are information to be deemed as sensitive image sections 4. The method is used to generate the encoded image 1, so that the encoded image 1 represents sensitive image sections 4 in anonymized form for the general public and/or unauthorized persons.

In method step 200, an image recognition algorithm is applied to the camera image 2, the image recognition algorithm being designed to recognize and/or detect the sensitive image sections 4 of the camera image 2. The detected sensitive image section 4 is shown highlighted and/or selected in method step 200.

In method step 300, an intermediate image 5 is generated. The intermediate image 5 is generated by anonymizing the sensitive image section 4. The anonymization in this exemplary embodiment is performed by replacing the actual sensitive image section (face) 4 of the camera image 2 by masking, for example, by blacking out or blurring. Alternatively, the anonymization is performed by replacing the actual sensitive image section 4 by an average face 6. For example, the average face 6 is selected to contain matching skin color, age and/or gender. Due to the anonymization by means of an average face 6, the intermediate images 5 appear to a third party to be highly realistic.

In method step 400, the encoded image 1 is generated based on the intermediate image 5. For this purpose, the image content of the sensitive image section 4, here the face of the camera image from method step 100 or 200, is cryptographically encoded and/or appended to and/or imprinted on the intermediate image 5 as a watermark 7. The intermediate image 5 together with the cryptographically encoded image content, in particular the watermark 7, forms the encoded image 1. The encoded image 1 can then be made available to third parties in a manner that complies with data protection, as the sensitive image regions are not recognizable to them.

1. A method for generating an encoded image (1),
wherein a camera system provides a camera image (2), wherein the camera image (2) comprises anonymous image sections (3) without personal data and sensitive image sections (4) containing personal data,
wherein the camera image (2) is analyzed based on an image recognition algorithm to detect the sensitive image sections (4),
wherein an encoded image (1) is generated, wherein in order to generate the encoded image (1) the sensitive image sections (4) of the camera image (2) are anonymized and image contents of the sensitive image sections (4) of the camera image are stored in the encoded image (1) in cryptographically encoded form.

2. The method according to claim 1, wherein in order to generate the encoded image (1), the camera image (2) with the anonymized sensitive image sections (4) forms an intermediate image (5), the cryptographically encoded sensitive image sections (4) being include in the intermediate image (5).

3. The method according to claim 1, wherein the cryptographic encoding is based on steganography.

4. The method according to claim 1, wherein the storage of the cryptographically encoded sensitive image sections (4) comprises an invisible storage of the image contents of the sensitive image sections in the encoded image (1), the intermediate image (2), or both.

5. The method according to claim 1, wherein the storage of the cryptographically encoded sensitive image contents (4) in the encoded image (1) and/or intermediate image (5) is based on a least-significant-bits algorithm and/or the intermediate image (5) is stored in DCT coefficients.

6. The method according to claim 1, wherein the cryptographically encoded image contents of the sensitive image contents (4) are included in the image section of the sensitive image contents (4).

7. The method according to claim 1, wherein to generate the encoded image (1) the image contents of the sensitive image sections (4) of the camera image (2) are stored as cryptographically encoded metadata in an encoded image header and/or encoded image attachment.

8. The method according to claim 1, wherein the sensitive image sections (4) include as least one selected from the group consisting of faces, number plates, and private information in textual form.

9. The method according to claim 1, wherein to anonymize one of the sensitive image sections (4) of the camera image (2) the image contents of the sensitive image section (4) are replaced by an average image content (6).

10. The method according to claim 1, wherein the sensitive image section (4) is anonymized by means of a generative adversarial network.

11. The method according to claim 1, wherein the cryptographic encoding is based on an asymmetric encryption.

12. A non-transitory, computer-readable storage medium containing instructions that when executed by a computer cause the computer to control a camera system to
provide a camera image (2), wherein the camera image (2) comprises anonymous image sections (3) without personal data and sensitive image sections (4) containing personal data,
analyze the camera image (2) based on an image recognition algorithm to detect the sensitive image sections (4),
generate an encoded image (1), wherein in order to generate the encoded image (1) the sensitive image sections (4) of the camera image (2) are anonymized and image contents of the sensitive image sections (4) of the camera image are stored in the encoded image (1) in cryptographically encoded form.

14. An electronic image analysis device, configured to
obtain a camera image (2), wherein the camera image (2) comprises anonymous image sections (3) without personal data and sensitive image sections (4) containing personal data,
analyze the camera image (2) based on an image recognition algorithm to detect the sensitive image sections (4),
generate an encoded image (1), wherein in order to generate the encoded image (1) the sensitive image sections (4) of the camera image (2) are anonymized and image contents of the sensitive image sections (4) of the camera image are stored in the encoded image (1) in cryptographically encoded form.

15. The electronic image analysis device according to claim 14, wherein the image recognition module is configure, in order to generate the encoded image (1), to anonymize the sensitive image sections (4) of the camera image (2) in the encoded image (1) and store image contents of the sensitive image sections (4) of the camera image in the encoded image (1) in cryptographically encoded form.
